(19) United States
(12) Patent Application Publication
(10) Pub. No.: US 2016/0165509 A1
(43) Pub. Date: Jun. 9, 2016

(54) SYSTEM FOR TRANSMITTING MESSAGE THROUGH HETEROGENEOUS NETWORKS BY GATEWAYS AND METHOD THEREOF

(71) Applicants: Inventec (Pudong) Technology Corporation, Shanghai (CN); Inventec Corporation, Taipei City (TW)

(72) Inventor: XIAO JIANG, Shanghai (CN)

(21) Appl. No.: 14/663,171

(22) Filed: Mar. 19, 2015

(30) Foreign Application Priority Data
Dec. 5, 2014 (CN) 201410737340.2

(51) Int. Cl. H04W 36/22; H04W 36/06

(52) U.S. Cl. CPC H04W 36/22; H04W 36/06; H04W 88/16

(57) ABSTRACT

The present invention discloses a system for transmitting a message through heterogeneous networks by gateways and method thereof. After using a wireless communication technology to transmit a message from a node to a gateway, a data transmission technology different from the wireless communication technology is used to transmit the message from the gateway to another gateway in different cells, so as to forward the message from the another gateway to another node by using the wireless communication technology, to decrease traffic generated by exchanging routing message in wireless network, and to achieve the effect of raising available bandwidth in the wireless network.

### CROSS-REFERENCE TO RELATED APPLICATION

This application claims the benefit of Chinese Patent Application No. 201410737340.2, filed Dec. 5, 2014.

### BACKGROUND OF THE RELATED ART

1. Technical Field

The present invention is related to message transmitting system and method thereof, more particularly to a system for adjusting a network architecture to transmit a message through heterogeneous networks by gateways and method thereof.

2. Related Art

A wireless network indicates any type of wireless computer networks, which uses a radio wave to be a carrier wave and a physical layer of the network in which nodes are connected with each other without cables.

In some current wireless networks, one wireless network has only one coordinator and at least one router at the same time. The routing message is exchanged frequently between the coordinator and each of the at least one router and between the one routers, so as to keep the reliability and instantaneity of routes.

However, once the number of the routers increases, the exchanged routing message will be transmitted abundantly in the wireless network between the coordinator and the at least one router and between any two of the routers, it causes that the bandwidth used by other nodes in the wireless network will be impacted and the wireless network will be paralyzed in the worst case.

In summary, a problem existed in prior arts in some of the wireless networks for a long time is that the routing message used in maintaining the reliability and the instantaneity occupies most part of the bandwidth of the network. Therefore, what is need is to propose a technical mean to solve this problem.

### SUMMARY

According to the problem that most part of the bandwidth is occupied by the routing message used in maintaining network architecture, the present invention illustrates a system for transmitting a message through heterogeneous networks by gateways and method thereof.

The disclosed system of transmitting a message through heterogeneous networks by gateways of the present invention at least includes multiple nodes and a target device. The multiple nodes are included in a first cell or a second cell, and the multiple nodes include gateways and routers, the routers are arranged according to a geometric pattern, the gateways of the multiple nodes are arranged in a 3D space formed by the geometric pattern, the gateway and the router of each of the multiple nodes are connected with each other by using the wireless communication technology, and the gateway is a parent node of the routers connected with each other. The gateways are connected with each other by using a data transmission technology different from the wireless communication technology. The target device is connected to one of the multiple nodes of the first cell through the wireless communication technology, and configured for transmitting the message to a destination node of the second cell via the gateway of the first cell and the gateway of the second cell.

The disclosed method of transmitting a message through heterogeneous networks by gateways of the present invention includes at least steps of: arranging multiple cells which includes a first cell and a second cell, and each of the multiple cells including multiple nodes, the multiple nodes including gateways and routers, the routers arranged according to a geometric pattern, the gateways of the multiple nodes arranged in a 3D space formed by the geometric pattern; connecting the gateway and the router of the multiple cells by using a wireless communication technology, to enable the gateway to become a parent node of the router; connecting the gateways with each other by using a data transmission technology different from the wireless communication technology; connecting a target device and one of the nodes of the first cell by using the wireless communication technology; and transmitting the message to a destination node of the second cell via the gateway of the first cell and the gateway of the second cell.

The system and method thereof of the present invention are shown as above. The difference between the prior arts and the present invention is that, after using the wireless communication technology to transmit a message from the node to the gateway, the data transmission technology different from the wireless communication technology is used to transmit the message from the gateway to another gateway in different cells, so that the gateway receiving the message can forward the message to another node by using the wireless communication technology. Therefore, the problem existed in the prior arts can be solved, and the effect of raising available bandwidth in the wireless network can be achieved.

### BRIEF DESCRIPTION OF THE DRAWINGS

The invention will become more fully understood from the detailed description given herein below illustration only, and thus is not limitative of the present invention, and wherein:

FIG. 1 is an architecture diagram of transmitting a message through heterogeneous networks by gateways of the present invention.

FIG. 2 is a layout diagram of transmitting a message through heterogeneous networks by gateways of the present invention.

FIG. 3A is a flow chart of transmitting a message through heterogeneous networks by gateways of the present invention.

FIG. 3B is a flow chart of reconnecting the target device and the router of the present invention.

### DETAILED DESCRIPTION

The present invention will be apparent from the following detailed description, which proceeds with reference to the accompanying drawings, wherein the same references relate to the same elements.

In the present invention, multiple gateways can be provided in a wireless network, so as to divide the wireless network into multiple cells by the multiple gateways. Simultaneously, the multiple gateways are connected with each other by the data transmission technology. When a target device directly or indirectly connected with one of the multiple gateway transmits the message to a destination node directly or indirectly connected with another gateway by using the wireless communication technology, the message may be transmitted and received between the above two gateways by using the data transmission technology, so that the message can be transmitted from the target device to the destination node through different cells. Furthermore, the message of the present invention includes data or signals, but the present invention is not limited thereto.

Besides, the proposed data transmission technology of the present invention may include wire or wireless communication technology, but the present invention is not limited thereto. The proposed wireless communication technology may include, but not limit to, Zigbee, Bluetooth, Wi-Fi and so on. The proposed wire communication technology may include, but not limit to, Ethernet and so on.

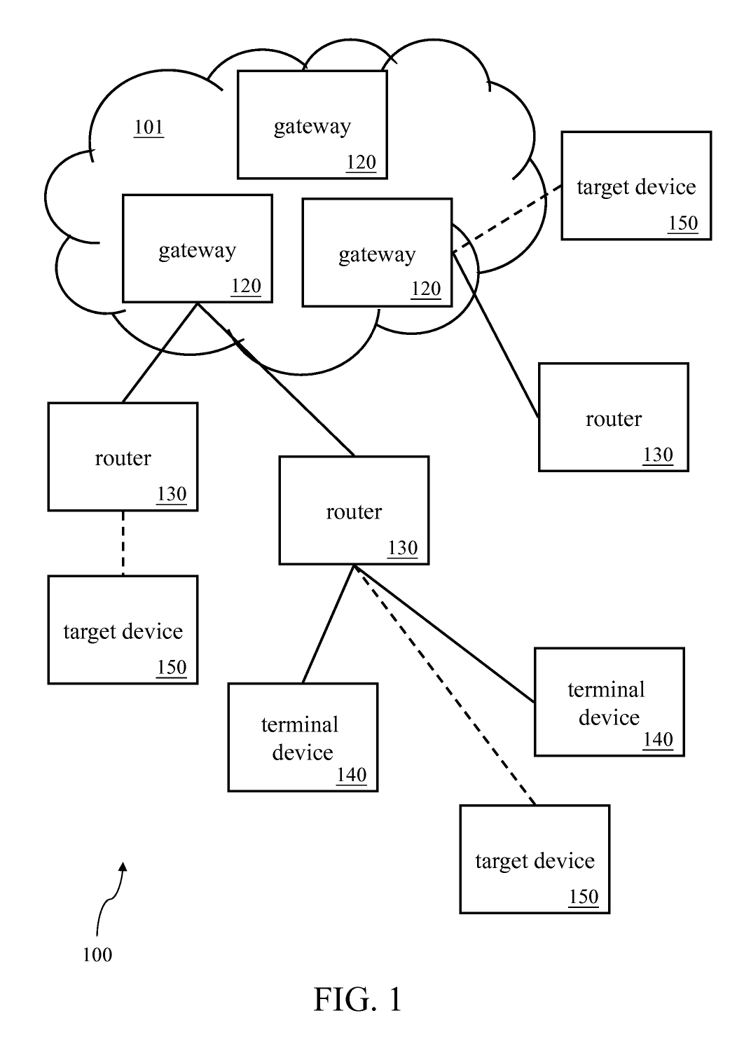

As shown in FIG. 1, the system of the present invention may be applied to a wireless network 100. The wireless network 100 includes multiple nodes, such as a gateway 120, a router 130, and an appendant terminal device 140.

The gateway 120 is connected with at least one router 130 by the wireless communication technology. In some embodiments, the gateway 120 becomes a parent node of the router 130 after being connected with the router 130.

Besides, the gateways 120 are connected with each other by using a data transmission technology different from the wireless communication technology used by the router 130.

The router 130 is connected with the gateway 120 by the wireless communication technology. Generally speaking, the router 130 is only connected with one gateway 120 at one time. Besides, the router 130 may be connected with the at least one terminal device 140 by the identical wireless communication technology. In some embodiments, the router 130 may become a parent node of the terminal device 140 after being connected with the terminal device 140.

The terminal device 140 may be connected with the router 130 by the wireless communication technology. Generally speaking, the terminal device 140 is only connected with one router 130 at a time.

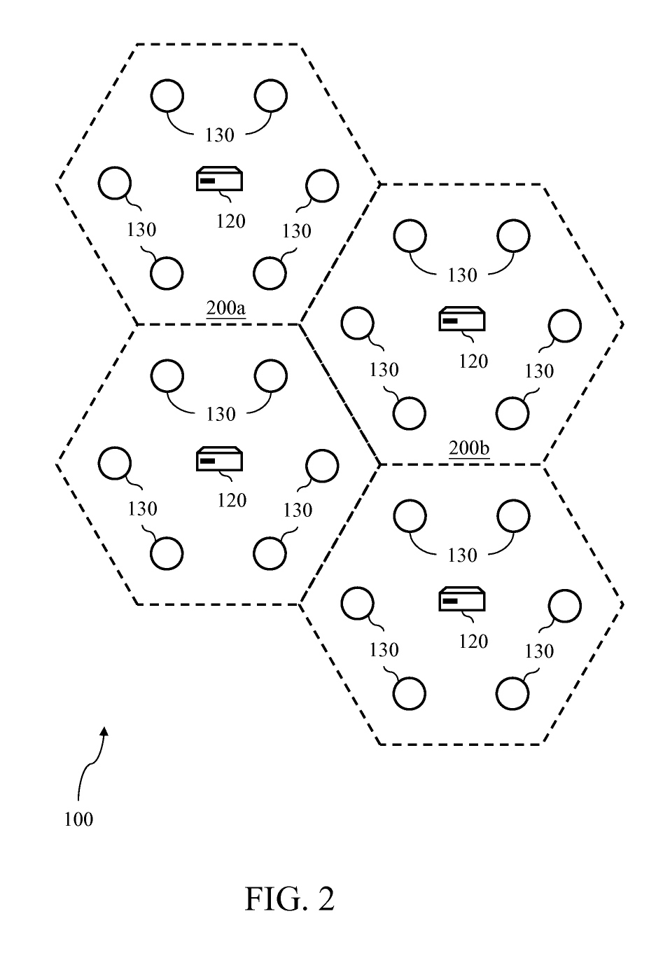

It is worth mentioning that the gateways 120 can be arranged in a 3D space formed by the geometric pattern. The multiple routers 130 are arranged according to the same geometric pattern, and the geometric pattern containing a gateway 120 and multiple routers 130 is called as “cell”. Please refer to FIG. 2 which shows a layout diagram of the nodes of the present invention. The geometric pattern which forms a cell (200a, 200b, 200c, and 200d) is a hexagon, but the present invention is not limited thereto, the geometric pattern may also be a triangle, a rectangle and so on.

Besides, an edge of each cell may be an effective distance of the wireless communication technology used to connect with the gateway 120 and the router 130. At the same time, the distance from the gateway 120 to the router 130 of each of the cells may also be the two-thirds of the effective distance of the above wireless communication technology, but the present invention is not limited thereto.

The system operation of the present invention is described in the following context. As shown in FIG. 1, the system of the present invention includes nodes containing the gateways 120 and the routers 130 in the wireless network 100, and it may further includes a target device 150.

The routing message can be exchanged by the gateway 120 and the router 130 which are connected with each other. Apart from exchanging the routing message with the gateway 120 connected therewith, the router 130 may also exchange the routing message with others routers in the same cell, but not exchange the routing message with others router in different cells. Therefore, compared with the prior arts, it is obvious that in the system of the present invention the huge traffic generated by exchanging routing message may be efficiently reduced.

The gateway 120 is used to determine whether the target device 150 is connected with the router 130 directly, so as to generate a reconnection message and to transmit the reconnection message to the target device 150 if the target device 150 is not connected with the router 130 directly.

In some embodiments, the gateway 120 may select the router 130 according to arrangements of the routers 130 connected therewith, and add a network address of the selected router 130 into the reconnection message, such that the reconnection message includes the network address of the selected router 130.

The target device 150 is used to connect with one of nodes in the wireless network 100, so as to add the target device 150 into the wireless network 100 after being connected with the nodes in the wireless network 100. After the target device 150 is added into the wireless network 100, the target device 150 becomes a new terminal device. Generally speaking, the target device 150 may detect signals of surrounding nodes, and then choose to connect with the node having the strongest signal first.

After the target device 150 receives the reconnection message from the gateway 120, the target device 150 selects a router 130 of the same cell to be reconnected. In some embodiments, the target device 150 may reconnect with the router 130 selected by the gateway 120 according to the network address of the router 130 included by the reconnection message, but the present invention is not limited thereto. For example, the target device 150 may also determine whether the detected node is a router 130 or not, and the target device 150 is then connected with the detected node if the detected node is determined to be the router 130. Besides, the target device 150 may also select to connect with one of the detected nodes, and repeat the process of receiving the reconnection message and reselecting detected nodes to be connected until no reconnection message is received.

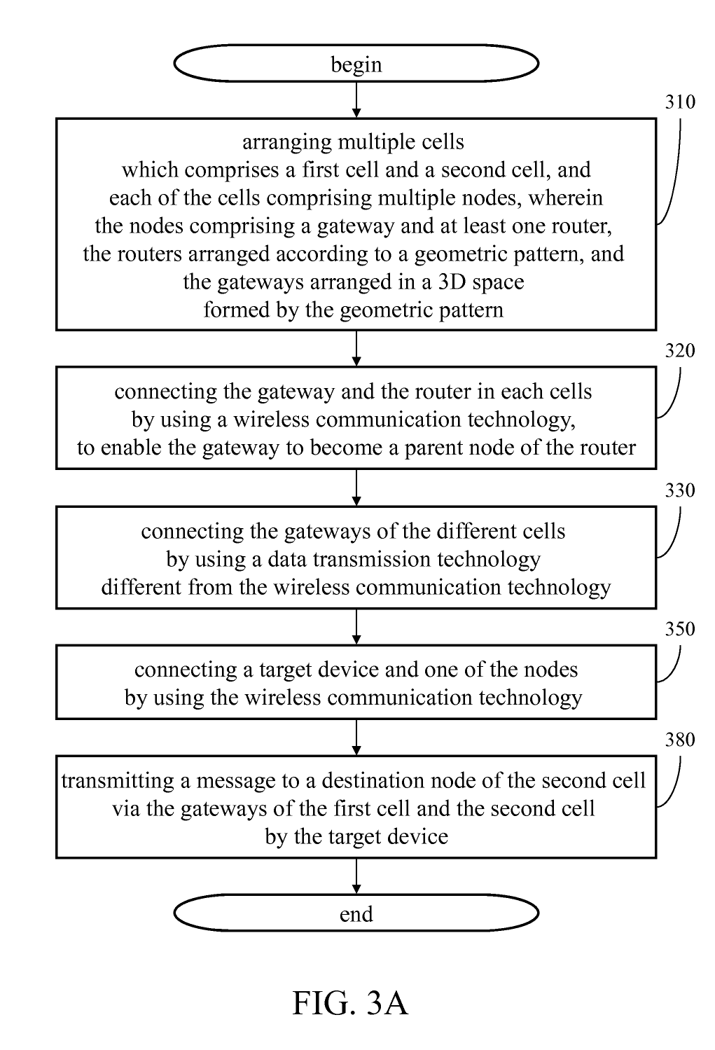

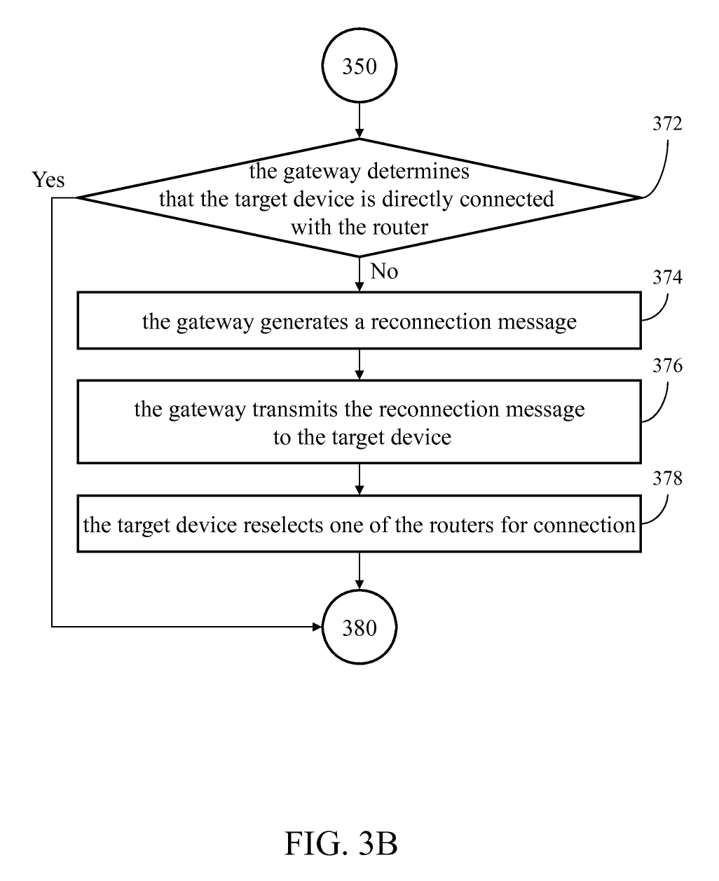

Next, an embodiment is described to explain the operating system and method thereof of the present invention. Please refer to FIG. 3A which is a flow chart of transmitting a message through heterogeneous networks by gateways of the present invention.

At first, multiple cells have to be arranged (step 310). In the embodiment, it's assumed that the geometric pattern of the cell is hexagon. A supervisor may arrange the gateway 120. The distance of each of gateways 120 is two times of an effective distance of the wireless communication technology used by the router 130 connected with the gateway 120, where the distance is the edge from the gateway 120 to the cell as well. Then, the supervisor may arrange the router 130 on the two-thirds of the edge of the gateway 120 towards the cell, as shown in FIG. 2.

After the cells are arranged (step 310), the gateway 120 is connected with the router 130 of each of the multiple cells 200 by using a wireless communication technology, and the gateway 120 is enabled to be a parent node of the router 130 (step 320). In the embodiment, it's assumed that the wireless communication technology used to connect the gateway 120 and the router 130 is Zigbee.

Similarly, after the arrangement of the cell is completed (step 310), the gateways 120 of the cells 200 are connected with each other by using a data transmission technology different from the wireless communication technology used in connecting the gateway 120 and the router 130. In the embodiment, it's assumed that gateways 120 can be connected with each other by using Ethernet 101, but the present invention is not limited thereto. For example, the gateways 120 can be connected with each other by using Wi-Fi.

After the connection between the gateway 120 and the router 130 of each cell and connection of the gateways 120 of the cells are completed, the target device 150 may be connected with the node of the cell by the wireless communication technology used in connecting the gateway 120 and the router 130 when the target device 150 wants to be added into the wireless network 100 (step 350). In the embodiment, it's assumed that the target device 150 is arranged in the first cell 200a and the target device 150 selects to connect with the router 130 having the strongest signal.

After the target device 150 is added into the wireless network 100, the target device 150 may become a terminal device in the wireless network 100. When the target device 150 needs to transmit the message, such as data or signal, to another terminal device 140 of a second cell 200b (it is called as “destination node” in the present invention), the target device 150 may transmit the message to the destination node of the second cell 200b via the gateway 120 of the first cell 200a and the gateway 120 of the second cell 200b (step 380). In the embodiment, the target device 150 may transmit the message to the router 130 connected with the target device 150 via Zigbee which is the wireless technology used in connecting the target device 150 and the router device 130 which is arranged in the first cell 200a. The message received by the router 130 can be forwarded to the gateway 120 of the first cell 200a via Zigbee. The gateway 120 of the first cell 200a may forward the message to the gateway 120 of the second cell 200b via Ethernet 101 which is the data transmission technology used to connect the gateway 120 of the first cell and the gateway 120 of the second cell. The gateway 120 of the second cell 200b may also forward the message to a router 130 connected with the destination node via the wireless communication technology, such as Zigbee. Then, the router 130 may transmit the received message to the destination node via Zigbee. The gateway 120 of the first cell 200a is further configured for transmitting the message to the gateway 120 of the second cell 200b according to the network address of the destination node.

Thus, by the present invention, the wireless network 100 may be divided into multiple cells by the gateways 120, to limit the routing message to be exchanged in each of the cells, so that the traffic generated by exchanging routing message can be reduced.

Besides, in above embodiments, as shown in FIG. 3B as well, after the target device 150 is connected with the nodes of the cells by the wireless communication technology used in connecting the gateway 120 and the router 130 (step 350), The gateway 120 of the first cell 200a in which the target device 150 is located may determine whether the target device 150 is connected with the router directly (step 372). In the embodiment, since the target device 150 is connected with the router 130 directly, the gateway 120 may not perform the sequential actions; in other words, the reconnection message will not be generated.

However, if the target device 150 is connected with the terminal device 140 instead of the router 130, the gateway 120 of the first cell 200a may generate the reconnection message (step 374) and transmit the reconnection message to the target device 150 through the router 130 by using the wireless communication technology (step 376). In the embodiment, it is assumed that the gateway 120 may select one router 130 according to arrangements of the routers 130 (routers 130 of the same cell) connected with each other and add a network address of the selected router 130 into the reconnection message.

After the target device 150 receives the reconnection message generated by the gateway 120, the target device 150 may reselect the router 130 of the first cell (step 378). In the embodiment, it is assumed that the target device 150 may select to reconnect with the router 130 selected by the gateway 120 according to the network address of the router 130 selected by the gateway 120 included by the reconnection message. Thus, since the target device 150 is a new terminal device 140 of the first cell and the target device 150 connects with the router 130 directly, the terminal devices 140 of the first cell may all connect with one of the router of the first cell.

In summary, the difference between the prior arts and the present invention is that the wireless network is divided into multiple cells by the multiple gateways, and the multiple cells use wireless communication technology to transmit a message to the gateway in the same cell, a data transmission technology different from the wireless communication technology is used to transmit the message from the gateway to another gateway in different cells, so as to forward the message from the gateway receiving the message to another node in the same cell by using the wireless communication technology. By this technical means, the problem that most parts of the bandwidth is occupied by the routing message used for maintaining network architecture in some wireless network can be solved, and the effect of raising available bandwidth in wireless network can be further achieved.

Furthermore, the method of transmitting a message through heterogeneous networks by gateways of the present invention can be implemented in hardware, software, or a combination of the hardware and the software both. It may also be implemented in a computer system by a centralized manner or by multiple components arranged in several computer systems connected with each other in a distributed manner.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of transmitting a message through heterogeneous networks by gateways, comprising:
arranging multiple cells which comprises a first cell and a second cell, and each of the cells comprising multiple nodes, the nodes comprising a gateway and at least one router, the at least one router of each of the cells arranged according to a geometric pattern, and the gateway of each of the cells arranged in a 3D space formed by the geometric pattern;
connecting the gateway and the at least one router of each of the cells by using a wireless communication technology, to enable the gateway to become a parent node of the at least one router;
connecting the gateways of the different cells by using a data transmission technology different from the wireless communication technology;
connecting a target device and one of the nodes of the first cell by using the wireless communication technology; and
transmitting a message to a destination node of the second cell via the gateway of the first cell and the gateway of the second cell by the target device.

2. The method as claimed in claim 1, wherein after the step of connecting the target device and the node of the first cell, the method further comprising: generating a reconnection message when the gateway of the first cell determines that the target device is not directly connected with the router; and reselecting one of the at least one router of the first cell for connection after the target device receives the reconnection message.

3. The method as claimed in claim 2, wherein in the step of generating the reconnection message by the gateway of the first cell, the gateway of the first cell selects one of the at least one router of the first cell according to arrangements of all the routers of the first cell, and adds a network address of the selected router into the reconnection message.

4. The method as claimed in claim 2, wherein in the step of reselecting the at least one router of the first cell by the target device, the target device is configured for receiving the reconnection message containing a network address, and selecting to connect the router using the network address.

5. The method as claimed in claim 1, wherein in the step of reselecting the at least one router of the first cell by the target device, the target device is configured for connecting to the router being detected when the target device determines one of the nodes being detected is one of the at least one router.

6. The method as claimed in claim 1, wherein the step of transmitting a message by the target device to a destination node of the second cell via the gateway of the first cell and the gateway of the second cell, further comprising the following steps: forwarding the message by the gateway of the first cell to the gateway of the second cell according to the network address of the destination node.

7. A system of transmitting a message through heterogeneous networks by gateways, applied to a wireless network, the system comprising:
multiple nodes, comprised in a first cell or a second cell, the multiple nodes in the first cell or the second cell comprising a gateway and at least one router, the at least one router of each of the cells arranged according to a geometric pattern, the gateway of each of the cells arranged in a 3D space formed by the geometric pattern, the gateway and the at least one router of each of the cells connected with each other by using a wireless communication technology, the gateway of each of the cells being a parent node of the at least one routers connected with each other, and the gateways of the different cells connected with each other by using a data transmission technology different from the wireless communication technology; and
a target device, connected to one of the nodes of the first cell through the wireless communication technology, and configured for transmitting a message to a destination node of the second cell via the gateway of the first cell and the gateway of the second cell.

8. The system as claimed in claim 7, wherein the gateway of the first cell further generates a reconnection message upon a determination that the target device is not directly connected with the at least one router of the first cell, and the target device is further configured for reselecting one of the at least one router of the first cell for connection on receipt of the reconnection message.

9. The system as claimed in claim 8, wherein the gateway of the first cell is further configured for selecting one of the at least one router of the first cell according to arrangements of all the routers of the first cell, and adding a network address of the selected router into the reconnection message.

10. The system as claimed in claim 8, wherein the target device is further configured for receiving the reconnection message containing the network address, and selecting to connect to the router using the network address.

11. The system as claimed in claim 7, wherein the target device further determines one of the nodes being detected is one of the at least one router, and is configured for connecting to the router being detected when the nodes being detected is one of the at least one router.

12. The system as claimed in claim 7, wherein the gateway of the first cell is further configured for forwarding the message to the gateway of the second cell according to the network address of the destination node.

13. The system as claimed in claim 7, wherein each of the router of the first cell further exchanges a routing message with the gateway of the first cell and the other router of the first cell.
